(19) United States
(12) Patent Application Publication
(10) Pub. No.: US 2023/0139566 A1
(43) Pub. Date: May 4, 2023

(54) TIRE

(71) Applicant: The Yokohama Rubber Co., LTD., Tokyo (JP)

(72) Inventor: Takashi KIDESAKI, Kanagawa (JP)

(21) Appl. No.: 17/907,634

(22) PCT Filed: Apr. 1, 2021
(86) PCT No.: PCT/JP2021/014235

§ 371 Date: Sep. 28, 2022

(30) Foreign Application Priority Data
Apr. 3, 2020 (JP) 2020-067884

(51) Int. Cl. B60C 11/03; B60C 11/12

(52) U.S. Cl. CPC B60C 11/0311; B60C 11/1263; B60C 2011/0355; B60C 2011/0348; B60C 2011/0346; B60C 2011/0313

(57) ABSTRACT

A tire includes a main groove extending in a circumferential direction, a lug groove extending in a width direction, a land portion defined by the main groove and the lug groove, and a sipe that is a narrow groove that is formed in the land portion, extends in the width direction, and includes an end opening to the main groove. The lug groove includes a raised bottom portion formed in a central region of the land portion in the width direction. The sipe includes shallow and deep bottom portions having different depths from a tread contact surface. A deep bottom portion depth from the tread contact surface is greater than a shallow bottom portion depth and includes at least a part disposed in the central region. The raised bottom portion and the deep bottom portion are disposed overlapping each other in the circumferential direction.

### TECHNICAL FIELD

The present technology relates to a tire.

### BACKGROUND ART

Known tires include a tire having a devised shape of a groove formed in a tread portion to provide running performance and wear performance in a compatible manner. For example, the tires described in Japan Patent Nos. 5210334 B, 4812041 B and 5639461 B, and Japan Unexamined Patent Publication Nos. 2018-095156 A and 2017-030531 A provide running performance, such as wet performance, traction performance on icy and snowy road surfaces, and steering stability, and wear performance in a compatible manner by devising, for example, an arrangement position, a depth, or a shape of a sipe.

Here, for a tire that requires running performance on icy and snowy road surfaces as well as running performance on road surfaces other than icy and snowy road surfaces, like an all-season tire with a severe snow service rating for light trucks, wear performance as a basic performance of a tire is also considered important. In general, many tires for which such wear performance is considered important are aimed at improving the wear performance by enhancing the rigidity of land portions. Unfortunately, improving the wear performance by enhancing the rigidity of land portions may easily cause uneven wear due to unevenness in the rigidity. Therefore, improving the wear performance without causing the uneven wear has been very difficult.

### SUMMARY

The present technology provides a tire that can provide wear performance and uneven wear resistance performance in a compatible manner.

To solve the problem and achieve the object described above, a tire according to the present technology includes a main groove extending in a tire circumferential direction, a lug groove extending in a tire width direction, a land portion defined by the main groove and the lug groove, and a narrow groove that is formed in the land portion, extends in the tire width direction, and includes at least one end opening to the main groove. The lug groove includes a raised bottom portion formed in a central region of the land portion in the tire width direction. The narrow groove includes a shallow bottom portion and a deep bottom portion having different depths from a tread contact surface. The deep bottom portion has a depth from the tread contact surface greater than a depth of the shallow bottom portion and includes at least part disposed in the central region. The raised bottom portion and the deep bottom portion are disposed overlapping each other in the tire circumferential direction.

Preferably, the lug groove and the narrow groove in the tire described above have a relationship between a maximum depth H1 of the lug groove from the tread contact surface and a maximum depth H2 of the narrow groove from the tread contact surface of within a range of 0.5≤(H2/H1)≤0.8.

Preferably, the lug groove and the narrow groove in the tire described above have a relationship between a depth D1 from the tread contact surface to the raised bottom portion of the lug groove and a depth D2 from the tread contact surface to the shallow bottom portion of the narrow groove of within a range of 0.8≤(D2/D1)≤1.2.

Preferably, the lug groove and the narrow groove in the tire described above have a relationship between a width W1 of the raised bottom portion of the lug groove and a width 2 of the deep bottom portion of the narrow groove of within a range of 0.7≤(W2/W1)≤1.2.

In the tire described above, preferably, the narrow groove includes a plurality of the deep bottom portions, and at least part of the deep bottom portions is disposed overlapping the raised bottom portion in the tire circumferential direction.

Preferably, the lug groove and the narrow groove in the tire described above have a relationship between the width W1 of the raised bottom portion of the lug groove and a width W3 of the shallow bottom portion located between the deep bottom portions in the narrow groove of within a range of 0.4≤(W3/W1)≤0.8.

In the tire described above, preferably, the lug groove and the narrow groove have a width WL of a portion in which the raised bottom portion and the deep bottom portion overlap with each other in the tire circumferential direction of 40% or more of the width W1 of the raised bottom portion. In the tire described above, preferably, the lug groove includes a plurality of bent portions bent in the tire circumferential direction while extending in the tire width direction, and the raised bottom portion is disposed between the bent portions.

The tire according to the present technology has an effect of providing wear performance and uneven wear resistance performance in a compatible manner.

### BRIEF DESCRIPTION OF DRAWINGS

FIG. 1 is a plan view illustrating a tread contact surface of a tread portion of a pneumatic tire according to an embodiment.

FIG. 2 is a cross-sectional view taken along A-Ain FIG. 1.

FIG. 3 is a cross-sectional view taken along B-B in FIG. 1.

FIG. 4 is a cross-sectional view taken along A-Ain FIG. 1 and is an explanatory diagram illustrating a relative positional relationship between a shoulder lug groove and a shoulder sipe.

FIG. 5 is a detailed view of a portion C in FIG. 4 and is an explanatory diagram illustrating a relationship between a width of a raised bottom portion that the shoulder lug groove has and a width of a deep bottom portion that the shoulder sipe has.

FIG. 6 is an explanatory diagram of a modified example of a tire pneumatic according to an embodiment and explanatory diagram of a case where a sipe includes one deep bottom portion.

FIG. 7A is a table showing results of performance evaluation tests performed on pneumatic tires.

FIG. 7B is a table showing results of performance evaluation tests performed on pneumatic tires.

### DETAILED DESCRIPTION

A tire according to an embodiment of the present technology will be described in detail below with reference to the drawings. However, the present technology is not limited to the embodiment. Constituents of the following embodiment include elements that can be substituted and easily conceived of by a person skilled in the art or that are essentially identical.

### Embodiments

In the following description, a description will be given using a pneumatic tire 1 as an example of the tire according to the embodiment of the present technology. The pneumatic tire 1 as an example of the tire can be inflated with any gas including air and inert gas, such as nitrogen.

Further, in the following description, the term “tire radial direction” refers to a direction orthogonal to a tire rotation axis (not illustrated) which is a rotation axis of a pneumatic tire 1, the term “inner side in the tire radial direction” refers to a side toward the tire rotation axis in the tire radial direction, and the term “outer side in the tire radial direction” refers to a side away from the tire rotation axis in the tire radial direction. The term “tire circumferential direction” refers to a circumferential direction with the tire rotation axis as a center axis. Additionally, the term “tire width direction” refers to a direction parallel with the tire rotation axis, the term “inner side in the tire width direction” refers to a side toward a tire equatorial plane (tire equator line) CL in the tire width direction, and the term “outer side in the tire width direction” refers to a side away from the tire equatorial plane CL in the tire width direction. The term “tire equatorial plane CL” refers to a plane that is orthogonal to the tire rotation axis and that runs through the center of the tire width of the pneumatic tire 1. The tire equatorial plane CL aligns, in a position in the tire width direction, with a center line in the tire width direction corresponding to a center position of the pneumatic tire 1 in the tire width direction. The tire width is the width in the tire width direction between portions each located on the outermost side in the tire width direction, or in other words, the distance between the portions that are farthest from the tire equatorial plane CL in the tire width direction. “Tire equator line” refers to a line in the tire circumferential direction of the pneumatic tire 1 that lies on the tire equatorial plane CL. In the description below, “tire meridian section” refers to a cross-section of the tire taken along a plane that includes the tire rotation axis.

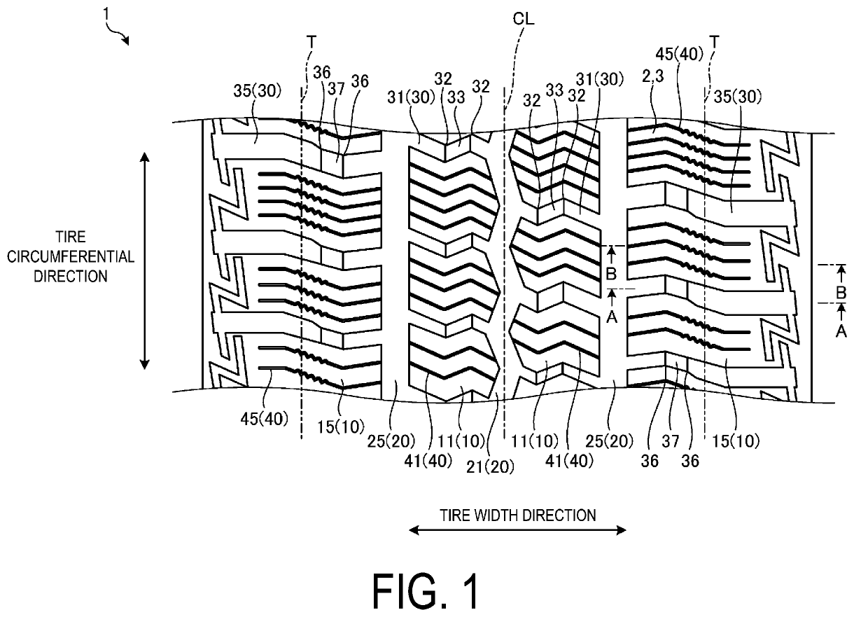

FIG. 1 is a plan view of a tread contact surface 3 of a tread portion 2 of the pneumatic tire 1 according to an embodiment. The pneumatic tire 1 illustrated in FIG. 1 has a tread portion 2 disposed at the outermost portion of the pneumatic tire 1 in the tire radial direction. The surface of the tread portion 2, in other words, a portion that comes into contact with a road surface when a vehicle (not illustrated) equipped with the pneumatic tire 1 travels is formed as the tread contact surface 3. A plurality of grooves is formed in the tread contact surface 3 on both sides in the tire width direction from the tire equatorial plane CL as a center, and a plurality of land portions 10 is defined by the plurality of grooves. The grooves include a plurality of main grooves 20 extending in the tire circumferential direction and a plurality of lug grooves 30 extending in the tire width direction, and the land portions 10 defined by the plurality of grooves are defined by the plurality of main grooves 20 and lug grooves 30.

In the present embodiment, three main grooves 20 are disposed side by side in the tire width direction, and of the three main grooves 20, one is disposed on the tire equatorial plane CL and the remaining two main grooves 20 are each disposed on either side of the tire equatorial plane CL in the tire width direction. Of the three main grooves 20 disposed side by side in the tire width direction, the main groove 20 disposed at the center in the tire width direction is provided as a center main groove 21, and the main groove 20 disposed on both sides of the center main groove 21 in the tire width direction is provided as a shoulder main groove 25. In other words, of the plurality of main grooves 20, the shoulder main groove 25 is the main groove 20 that is located on the outermost side in the tire width direction on both sides of the tire equatorial plane CL in the tire width direction.

Of the plurality of main grooves 20, the center main groove 21 is formed repeatedly bent in the tire width direction while extending in the tire circumferential direction. In other words, the center main groove 21 oscillates in the tire width direction while extending in the tire circumferential direction to form a zigzag shape. The shoulder main groove 25 is formed linearly extending in the tire circumferential direction. The main grooves 20 formed in the above-described manner have a groove width of within a range from 7.0 mm or more to 15.0 mm or less, and a groove depth of within a range from 8.0 mm or more to 12.0 mm or less.

In addition, of the plurality of land portions 10, the land portion 10 located on the inner side of the shoulder main groove 25 in the tire width direction is a center land portion 11, and the land portion 10 located on the outer side of the shoulder main groove 25 in the tire width direction is a shoulder land portion 15. In the present embodiment, one center main groove 21 is disposed on the tire equatorial plane CL between two shoulder main grooves 25 each located on either side of the tire equatorial plane CL in the tire width direction, and two rows of the center land portions 11 located on the inner side of the shoulder main groove 25 in the tire width direction are disposed on both sides of the center main groove 21 in the tire width direction. In other words, both of the two rows of the center land portions 11 located on the inner sides of the shoulder main grooves 25 in the tire width direction are defined by the center main groove 21 on the inner side in the tire width direction and are defined by the shoulder main groove 25 on the outer side in the tire width direction. In addition, both of two rows of the shoulder land portions 15 disposed on the respective outer sides of the two shoulder main grooves 25 in the tire width direction are defined by the shoulder main groove 25 on the inner side in the tire width direction.

The lug groove 30 has a groove width within a range of 5.0 mm or more to 10.0 mm or less, and a groove depth within a range of 8.0 mm or more to 12.0 mm or less. The lug groove 30 is disposed on the inner side and the outer side of the shoulder main groove 25 in the tire width direction. Of the plurality of the lug grooves 30, the lug groove 30 located on the inner side of the shoulder main groove 25 in the tire width direction is a center lug groove 31. A plurality of the center lug grooves 31 is disposed side by side in the tire circumferential direction on both sides of the center main groove 21 in the tire width direction. Both of the center lug grooves 31 located on both sides of the center main groove 21 in the tire width direction include an inner end portion in the tire width direction that opens to the center main groove 21 and an outer end portion in the tire width direction that opens to the shoulder main groove 25. The center lug grooves 31 located on both sides of the center main groove 21 in the tire width direction are disposed at positions different from each other in the tire circumferential direction.

The center lug groove 31 is bent a plurality of times in the tire circumferential direction while extending in the tire width direction. In other words, the center lug groove 31 includes a plurality of bent portions 32. In this case, at least one groove wall of a pair of groove walls forming the center lug groove 31 is bent in the tire circumferential direction while extending in the tire width direction, making the bent portion 32 a portion at which the center line of a groove width is bent in the tire circumferential direction while extending in the tire width direction. In the present embodiment, each center lug groove 31 is bent twice in the tire circumferential direction while extending in the tire width direction, and thus each center lug groove 31 includes two bent portions 32.

In addition, a raised bottom portion 33 is formed in the groove bottom of the center lug groove 31 at a position between an end portion on the side of the center main groove 21 and an end portion on the side of the shoulder main groove 25. The raised bottom portion 33 is disposed in a portion between two bent portions 32 in the center lug groove 31 and is connected to both of the center land portions 11 located on both sides of the center lug groove 31 in the tire circumferential direction. Both ends of the center lug groove 31 open to the main grooves 20, and the center land portion 11 is formed as a land portion 10 having a so-called block shape having both sides in the tire width direction defined by the main grooves 20 and both sides in the tire circumferential direction defined by the lug grooves 30.

Of the plurality of lug grooves 30, the lug groove 30 disposed on the outer side of the shoulder main groove 25 in the tire width direction is a shoulder lug groove 35. A plurality of shoulder lug grooves 35 is disposed side by side in the tire circumferential direction in each of the two rows of the shoulder land portions 15, and each shoulder lug groove 35 includes an inner end portion in the tire width direction that opens to the shoulder main groove 25. Further, the shoulder lug groove 35 is formed across ground contact edge T in the tire width direction. Accordingly, the shoulder lug groove 35 is disposed from the position of the shoulder main groove 25 located on the inner side of the ground contact edge Tin the tire width direction to the outer side of the ground contact edge Tin the tire width direction. The shoulder lug groove 35 is formed across the ground contact edge Tin the tire width direction as described above, and the shoulder land portion 15 defined by the shoulder lug grooves 35 is formed as the land portion 10 having a substantially block shape in which a portion located on the inner side of the ground contact edge Tin the tire width direction is divided by the shoulder lug grooves 35 adjacent to each other in the tire circumferential direction.

The ground contact edge T here refers to both outermost edges of a region contacting a flat plate on the tread contact surface 3 in the tire width direction when the pneumatic tire 1 is mounted on a regular rim, inflated to a regular internal pressure, placed perpendicular to the flat plate in a stationary state, and loaded with a load corresponding to a regular load, and continues in the tire circumferential direction. Here, “regular rim” refers to a “standard rim” defined by JATMA (The Japan Automobile Tyre Manufacturers Association, Inc.), a “Design Rim” defined by TRA (The Tire and Rim Association, Inc.), or a “Measuring Rim” defined by ETRTO (The European Tyre and Rim Technical Organisation). Moreover, a regular internal pressure refers to a “maximum air pressure” defined by JATMA, the maximum value in “TIRE LOAD LIMITS AT VARIOUS COLD INFLATION PRESSURES” defined by TRA, or “INFLATION PRESSURES” defined by ETRTO. The regular load refers to a “maximum load capacity” defined by JATMA, a maximum value in “TIRE LOAD LIMITS AT VARIOUS COLD INFLATION PRESSURES” defined by TRA, or a “LOAD CAPACITY” defined by ETRTO.

In addition, the shoulder lug groove 35 is bent a plurality of times in the tire circumferential direction while extending in the tire width direction. In other words, the shoulder lug groove 35 includes a plurality of bent portions 36 bent in the tire circumferential direction while extending in the tire width direction. At least one groove wall of a pair of groove walls constituting the shoulder lug groove 35 is bent in the tire circumferential direction while extending in the tire width direction, and thus the bent portion 36 in this case is a portion at which the center line of a groove width is bent in the tire circumferential direction while extending in the tire width direction. In the present embodiment, the shoulder lug grooves 35 include the bent portion 36 at which both of the pair of groove walls are bent and the bent portion 36 at which only one of the pair of groove walls is bent, and each shoulder lug groove 35 includes a plurality of the bent portions 36 formed as described above on the inner side of the ground contact edge Tin the tire width direction. In addition, a raised bottom portion 37 is formed in the groove bottom of the shoulder lug groove 35 at a position on the inner side of the ground contact edge Tin the tire width direction. The raised bottom portion 37 is disposed between the bent portions 36 included in the shoulder lug groove 35 and is connected to both of the shoulder land portions 15 located on both sides of the shoulder lug groove 35 in the tire circumferential direction.

Also, a plurality of sipes 40, which are narrow grooves, is formed in the tread contact surface 3, and each of the sipes 40 is formed extending in the tire width direction and at least one end portion thereof opens to the main groove 20. The sipes 40 are disposed in each of the land portions 10, i.e., the center land portions 11 and the shoulder land portions 15. In other words, center sipes 41 are disposed in the center land portions 11, and shoulder sipes 45 are disposed in the shoulder land portions 15.

The sipes 40 described here are formed in a narrow groove shape in the tread contact surface 3. In the sipes 40, when the pneumatic tire 1 is mounted on a regular rim and inflated to a regular internal pressure, wall surfaces constituting the narrow groove do not come in contact with each other in a case where no load is applied to the pneumatic tire 1, while the wall surfaces constituting the narrow groove or at least parts of portions provided on the wall surfaces come in contact with each other due to the deformation of the land portion 10 in a case where the narrow groove is located in a portion of the ground contact surface formed on a flat plate when a load is applied to the pneumatic tire 1 on the flat plate in the vertical direction or in a case where the land portion 10 provided with the narrow groove flexes. In the present embodiment, the sipe 40 has a sipe width, which is a space between the wall surfaces constituting the narrow groove, of less than 1.0 mm, and a maximum depth from the tread contact surface 3 within a range of 1.0 mm or more to 8.0 mm or less.

The center sipe 41, which is the sipe 40 disposed in the center land portion 11, is formed extending in the tire width direction, and both end portions thereof open to the main groove 20. In other words, the center sipe 41 includes an inner end portion in the tire width direction that opens to the center main groove 21 and an outer end portion in the tire width direction that opens to the shoulder main groove 25. Further, the center sipe 41 is formed substantially parallel to the center lug groove 31. Thus, the center sip e 41 is bent twice in the tire circumferential direction while extending in the tire width direction, similarly to the center lug groove 31.

The number of the center sipes 41, which are formed in this manner and disposed between the center lug grooves 31 adjacent to each other in the tire circumferential direction, varies depending on the size of a pitch between the center lug grooves 31 adjacent to each other in the tire circumferential direction. In other words, the center lug grooves 31 have a plurality of pitches having different sizes over a full circumference in the tire circumferential direction as spaces between the center lug grooves 31 adjacent to each other in the tire circumferential direction, that is, as pitches in the tire circumferential direction. For this reason, the pitches between the center lug grooves 31 adjacent to each other in the tire circumferential direction are not identical over the full circumference in the tire circumferential direction, and portions where the center lug grooves 31 are disposed at different pitches are included. The number of the center sipes 41 disposed between the center lug grooves 31 adjacent to each other in the tire circumferential direction is large in a portion where a pitch between the center lug grooves 31 adjacent to each other in the tire circumferential is relatively large and is small in a portion where the pitch is relatively small of the portions where the center lug grooves 31 adjacent to each other in the tire circumferential direction are disposed at different pitches as described above.

The shoulder sipe 45, which is the sipe 40 disposed in the shoulder land portion 15, is formed extending in the tire width direction, opens to the shoulder main groove 25 at an inner end portion in the tire width direction, and extends from the position of the shoulder main groove 25 toward the outer side in the tire width direction. Further, the shoulder sipe 45 is formed across the ground contact edge Tin the tire width direction extending in the tire width direction and terminates in the shoulder land portion 15 at an end portion on a side opposite to the side opening to the shoulder main groove 25. Furthermore, the shoulder sipe 45 oscillates a plurality of times in the tire circumferential direction while extending in the tire width direction in a partial area between both end portions in the extension direction of the shoulder sipe 45.

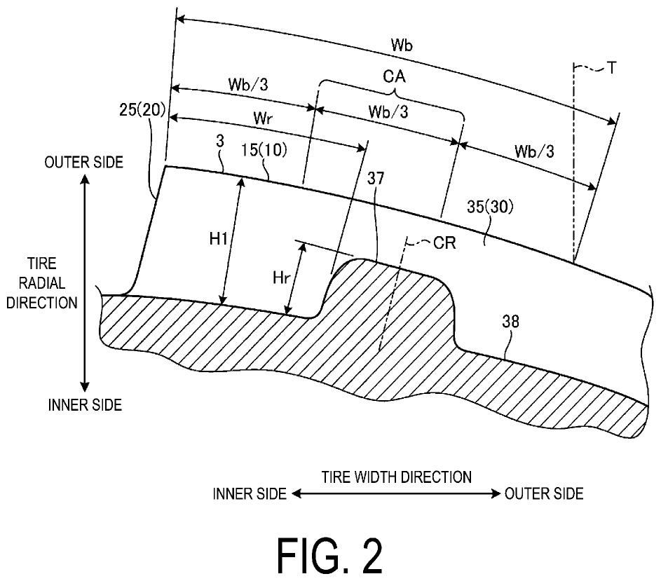

In addition, similarly to the center sipes 41 disposed in the center land portions 11, the number of the shoulder sipes 45 disposed varies depending on a size of a pitch between the shoulder lug grooves 35 adjacent to each other. In other words, similarly to the center lug grooves 31, the shoulder lug grooves 35 adjacent to each other in the tire circumferential direction are disposed at a plurality of pitches having different sizes. The number of the shoulder sipes 45 disposed between the shoulder lug grooves 35 adjacent to each other in the tire circumferential direction is large in a portion where a pitch between the shoulder lug grooves 35 adjacent to each other in the tire circumferential is relatively large and is small in a portion where the pitch is relatively small of the portions where the shoulder lug grooves 35 adjacent to each other in the tire circumferential direction are disposed at different pitches as described above. FIG. 2 is a cross-sectional view taken along A-A of FIG. 1. The raised bottom portion 37 formed in the shoulder lug groove 35 is formed protruding outward in the tire radial direction from a groove bottom 38 of the shoulder lug groove 35 and is located in a central region CA of the shoulder land portion 15 in the tire width direction. The central region CA in this case is a region located at the center among three regions obtained by equally dividing a ground contact width Wb of the shoulder land portion 15 in the tire width direction. The ground contact width Wb of the shoulder land portion 15 is a width of a region from an edge of the shoulder land portion 15 defined by the shoulder main groove 25 to the ground contact edge T located on the shoulder land portion 15 in the tire width direction. In other words, the central region CA of the shoulder land portion 15 in the tire width direction is a region located at the center among three regions obtained by equally dividing the ground contact width Wb from the edge of the shoulder land portion 15 defined by the shoulder main groove 25 to the ground contact edge T along the tread contact surface 3 in a tire meridian cross-sectional view. In the raised bottom portion 37 formed in the shoulder lug groove 35, a center line CR of the raised bottom portion 37 in the tire width direction is located in the central region CA, that is, the raised bottom portion 37 is disposed such that the center of the raised bottom portion 37 in the tire width direction is located in the central region CA.

Further, a distance Wr from the shoulder main groove 25 to the raised bottom portion 37 in the tire width direction, that is, a distance Wr from an edge of the shoulder land portion 15 defined by the shoulder main groove 25 to the raised bottom portion 37 in the tire width direction with respect to the ground contact width Wb of the shoulder land portion 15 is within a range of 0.3≤(Wr/Wb)≤0.5.

Furthermore, a height Hr of the raised bottom portion 37 formed in the shoulder lug groove 35 from the groove bottom 38 of the shoulder lug groove 35 with respect to a maximum depth H1 of the shoulder lug groove 35 from the tread contact surface 3 is within a range of 0.4≤(Hr/H1)≤0.6. The maximum depth H1 of the shoulder lug grooves 35 in this case is a maximum depth from the tread contact surface 3 to the groove bottom 38 at a position other than the raised bottom portion 37 in the shoulder lug groove 35.

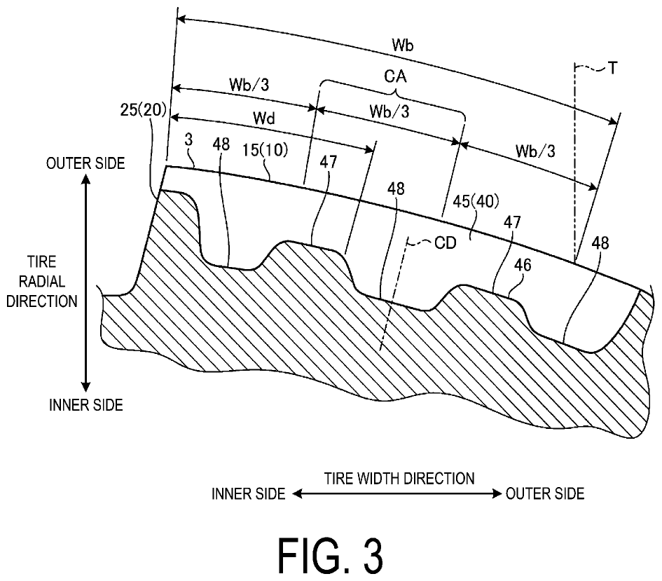

FIG. 3 is a cross-sectional view taken along B-B in FIG. 1. Note that a plurality of shoulder sipes 45 is disposed in each of the shoulder land portions 15, and the plurality of shoulder sipes 45 disposed in one shoulder land portion 15 is formed in a shape substantially identical to each other. The shoulder sipe 45 disposed in the shoulder land portion 15 includes a shallow bottom portion 47 and a deep bottom portion 48 having different depths from the tread contact surface 3. In other words, a depth of the shoulder sipe 45 from the tread contact surface 3 to a bottom portion 46 varies depending on positions in the extension direction of the shoulder sipe 45, and the shallow bottom portion 47 and the deep bottom portion 48 are portions where relative depths from the tread contact surface 3 differ from each other. Specifically, the deep bottom portion 48 has a depth from the tread contact surface 3 to the bottom portion 46 greater than a depth of the shallow bottom portion 47 from the tread contact surface 3 to the bottom portion 46.

In addition, the shoulder sipe 45 includes a plurality of shallow bottom portions 47 and a plurality of deep bottom portions 48. In other words, in the shoulder sipe 45, the shallow bottom portions 47 and the deep bottom portions 48 are alternately disposed in the extension direction of the shoulder sipe 45. In the shoulder sipe 45, part of the deep bottom portion 48 of the plurality of deep bottom portions 48 formed as described above is located in the central region CA of the shoulder land portion 15 in the tire width direction. In the deep bottom portion 48 located in the central region CA, a center line CD of the same deep bottom portion 48 in the tire width direction is located in the central region CA, that is, part of the deep bottom portion 48 of the plurality of deep bottom portions 48 is disposed such that the center of the deep bottom portion 48 in the tire width direction is located in the central region CA.

In this way, for the deep bottom portion 48 having the center line CD located in the central region CA of the shoulder land portion 15, a distance Wd from the shoulder main groove 25 in the tire width direction, that is, a distance Wd from an edge of the shoulder land portion 15 defined by the shoulder main groove 25 to the deep bottom portion 48 in the tire width direction with respect to the ground contact width Wb of the shoulder land portion 15 is within a range of 0.2≤(Wd/Wb)≤0.4.

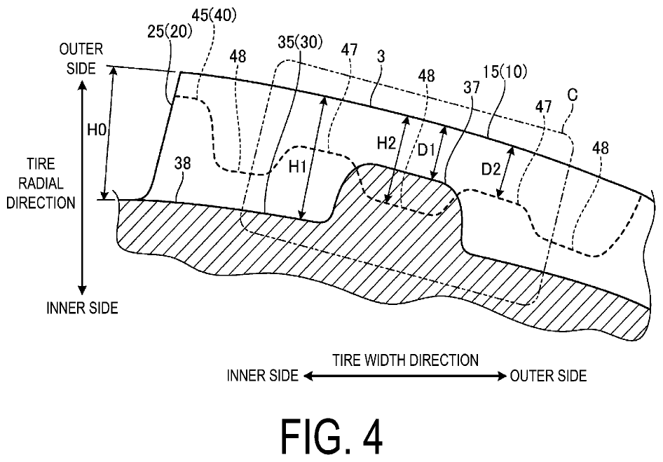

FIG. 4 is a cross-sectional view taken along A-Ain FIG. 1 and is an explanatory diagram illustrating a relative positional relationship between the shoulder lug groove 35 and the shoulder sipe 45. The raised bottom portion 37 of the shoulder lug groove 35 and the deep bottom portion 48 of the shoulder sipe 45 are disposed overlapping each other in the tire circumferential direction. In other words, the shoulder sipe 45 is disposed such that at least part of the deep bottom portion 48 of the plurality of deep bottom portions 48 overlaps with the raised bottom portion 37 of the shoulder lug groove 35 in the tire circumferential direction. Specifically, the raised bottom portion 37 and the deep bottom portions 48 are disposed including a portion in which the deep bottom portion 48 having a center in the tire width direction located in the central region CA of the deep bottom portions 48 included in the shoulder sipe 45 overlaps the raised bottom portion 37 of the shoulder lug groove 35 in the tire circumferential direction. In other words, the deep bottom portion 48 of the shoulder sipe 45 having the center of the deep bottom portion 48 in the tire width direction located in the central region CA and the raised bottom portion 37 of the shoulder lug groove 35 are disposed overlapping each other when viewed in the tire circumferential direction.

For the shoulder lug groove 35 and the shoulder sipe 45 formed as described above, the relationship between the maximum depth H1 of the shoulder lug groove 35 from the tread contact surface 3 and the maximum depth H2 of the shoulder sipe 45 from the tread contact surface 3 is within a range of 0.5≤(H2/H1)≤0.8. The maximum depth H2 of the shoulder sipe 45 in this case is a maximum depth of the shoulder sipe 45 at the position of the deep bottom portion 48.

In addition, the maximum depth H1 of the shoulder lug groove 35 with respect to a groove depth H0 of the shoulder main groove 25 is within a range of 0.7≤(H1/H0)≤1.0. In the present embodiment, the maximum depth H1 of the shoulder lug groove 35 is substantially identical to the groove depth H0 of the shoulder main groove 25, i. e., H1≈H0.

Further, for the shoulder lug groove 35 and the shoulder sipe 45, the relationship between the depth D1 from the tread contact surface 3 to the raised bottom portion 37 of the shoulder lug groove 35 and the depth D2 from the tread contact surface 3 to the shallow bottom portion 47 of the shoulder sipe 45 is within a range of 0.8≤(D2/D1)≤1.2.

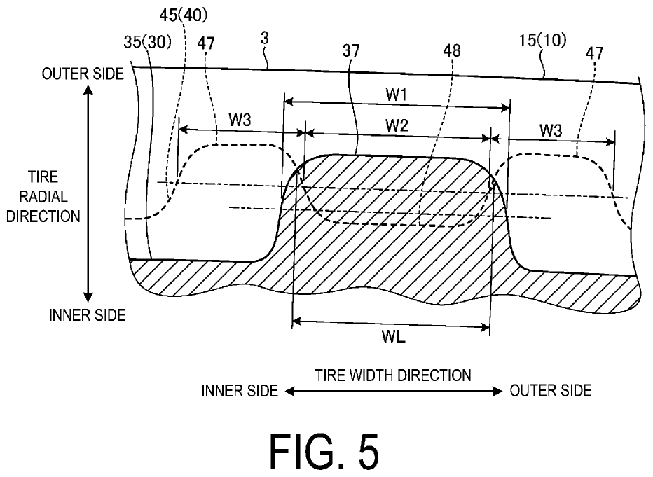

FIG. 5 is a detailed view of the portion C in FIG. 4 and is an explanatory diagram illustrating the relationship between the width of the raised bottom portion 37 included in the shoulder lug groove 35 and the width of the deep bottom portion 48 included in the shoulder sipe 45. Further, for the shoulder lug groove 35 and the shoulder sipe 45, the relationship between the width W1 of the raised bottom portion 37 of the shoulder lug groove 35 and the width W2 of the deep bottom portion 48 of the shoulder sipe 45 is within a range of 0.7≤(W2/W1)≤1.2. Furthermore, the relationship between the width W1 of the raised bottom portion 37 of the shoulder lug groove 35 and the ground contact width Wb (see FIGS. 2 and 3) of the shoulder land portion 15 is within a range of 0.15≤(W1/Wb)≤0.25, and the relationship between the width W2 of the deep bottom portion 48 of the shoulder sipe 45 and the ground contact width Wb of the shoulder land portion 15 is within a range of 0.1≤(W2/Wb)≤0.2.

The width W1 of the raised bottom portion 37 of the shoulder lug groove 35 in this case is a width of the raised bottom portion 37 in an extension direction of the shoulder lug groove 35 at a position corresponding to 50% of the height of the raised bottom portion 37 in a depth direction of the shoulder lug groove 35. In other words, the width W1 of the raised bottom portion 37 of the shoulder lug groove 35 is a width of the raised bottom portion 37 in the extension direction of the shoulder lug groove 35 at a middle position in the depth direction of the shoulder lug groove 35 between a portion of the shoulder lug groove 35 having a deepest groove depth and a portion of the raised bottom portion 37 located closest to the tread contact surface 3.

Also, the width W2 of the deep bottom portion 48 of the shoulder sipe 45 is a width of the deep bottom portion 48 in the extension direction of the shoulder sipe 45 at a position 50% of the depth of the deep bottom portion 48 with reference to the shallow bottom portion 47. In other words, the width W2 of the deep bottom portion 48 of the shoulder sipe 45 is a width of the deep bottom portion 48 in the extension direction of the shoulder sipe 45 at a middle position in the depth direction of the shoulder sipe 45 between a portion of the deep bottom portion 48 having the maximum depth in the depth direction of the shoulder sipe 45 and a portion of the shallow bottom portion 47 located closest to the tread contact surface 3.

In addition, for the raised bottom portion 37 of the shoulder lug groove 35 and the deep bottom portion 48 of the shoulder sipe 45 disposed overlapping each other in the tire circumferential direction, a width WL of an overlapped portion in which the raised bottom portion 37 and the deep bottom portion 48 overlap with each other in the tire circumferential direction is 40% or more of the width W1 of the raised bottom portion 37.

Further, for the shoulder lug groove 35 and the shoulder sipe 45, the relationship between the width W1 of the raised bottom portion 37 of the shoulder lug groove 35 and a width W3 of the shallow bottom portion 47 located between the deep bottom portions 48 in the shoulder sipe 45 is within a range of 0.4≤(W3/W1)≤0.8. The width W3 of the shallow bottom portion 47 of the shoulder sipe 45 in this case is a width of the shallow bottom portion 47 in the extension direction of the shoulder sipe 45 at a position corresponding to 50% of the height of the shallow bottom portion 47 with reference to the deep bottom portion 48. In other words, the width W3 of the shallow bottom portion 47 of the shoulder sipe 45 is a width of the shallow bottom portion 47 in the extension direction of the shoulder sipe 45 at a position having a depth identical to a reference depth for measuring the width W2 of the deep bottom portion 48 of the shoulder sipe 45 in the depth direction of the shoulder sipe 45.

The pneumatic tire 1 according to the present embodiment is, for example, a pneumatic tire 1 for light trucks to be mounted on light trucks. In the event of mounting the pneumatic tire 1 on a vehicle, the pneumatic tire 1 is mounted on a rim wheel and inflated with air inside to an inflated state, and then mounted to the vehicle. When the vehicle with the pneumatic tire 1 mounted travels, the pneumatic tire 1 rotates with a portion located lower of the tread contact surface 3 of the tread portion 2 in contact with a road surface. When the vehicle on which the pneumatic tire 1 is mounted travels on a dry road surface, the vehicle travels mainly by transmitting a driving force and a braking force to the road surface and generating a turning force by friction forces between the tread contact surface 3 and the road surface. In addition, during traveling on wet road surfaces, water between the tread contact surface 3 and the road surface enters grooves such as the main grooves 20 and the lug grooves 30, and the sipes 40, and the vehicle travels while draining the water between the tread contact surface 3 and the road surface by these grooves. As a result, the tread contact surface 3 easily contacts the road surface, and the vehicle can travel by the friction force between the tread contact surface 3 and the road surface.

When the vehicle travels on snow-covered road surfaces or icy road surfaces, the vehicle travels using the edge effect of the main grooves 20, the lug grooves 30, and the sipes 40. In other words, when the vehicle travels on snow-covered road surfaces or icy road surfaces, the vehicle travels using the resistance caused by the edges of the main grooves 20, the edges of the lug grooves 30, and the edges of the sipes 40 being caught on snow surfaces or ice surfaces. Also, when the vehicle travels on icy road surfaces, water on the icy road surface is absorbed by the sipes 40 to remove water films between the icy road surface and the tread contact surface 3, so that the contact between the icy road surface and the tread contact surface 3 is facilitated. As a result, the resistance between the tread contact surface 3 and the icy road surface is increased due to a frictional force and the edge effect, making it possible to ensure the running performance of the vehicle mounted with the pneumatic tire 1.

In addition, when the vehicle travels on snow-covered road surfaces, the pneumatic tire 1 presses and compacts snow on the road surface with the tread contact surface 3, and the snow on the road surface enters the lug grooves 30 and is pressed and compacted inside the grooves. In this state, when a driving force or a braking force acts on the pneumatic tire 1, a so-called snow column shear force, which is a shear force acting on the snow inside the grooves, is generated between the pneumatic tire 1 and the snow. When the vehicle travels on snow-covered road surfaces, a resistance occurs between the pneumatic tire 1 and the road surface due to the snow column shear force, and thus the driving force or the braking force can be transmitted to the road surface, and snow traction properties can be ensured. This allows the vehicle to ensure the running performance on snow-covered road surfaces.

The vehicle mounted with the pneumatic tire 1 travels with the tread contact surface 3 in contact with the road surface as described above, and thus the tread portion 2 gradually wears from a side of the tread contact surface 3 in the land portion 10. The pneumatic tire 1 mainly used by being mounted on a light truck requires wear performance which is durability against wear, and the wear performance can be improved by increasing the rigidity of the land portion 10 so that the land portion 10 is not easily worn.

In the pneumatic tire 1 according to the present embodiment, the raised bottom portion 37 is disposed in the shoulder lug groove 35 at a position corresponding to the central region CA of the shoulder land portion 15 in the tire width direction, and thus the rigidity of the shoulder land portion 15 defined by the shoulder lug grooves 35 is high. In other words, in the pneumatic tire 1 according to the present embodiment, the raised bottom portion 37 is disposed in the central region CA of the land portion 10 in the lug groove 30, and thus the land portion 10 defined by the lug grooves 30 has high rigidity over the entire tire width direction centered on the central region CA. Accordingly, the land portion 10 defined by the lug grooves 30 in which the raised bottom portion 37 is disposed is not easily worn, and the pneumatic tire 1 according to the present embodiment has high wear performance.

On the other hand, in a case where the rigidity of the land portion 10 is increased by disposing the raised bottom portion 37 in the lug grooves 30, there is a concern that unevenness in the rigidity of the land portion 10 defined by the lug grooves 30 in which the raised bottom portion 37 is disposed is likely to occur depending on positions in the tire width direction. In other words, when the raised bottom portion 37 is disposed in the central region CA of the land portion 10, the rigidity of the land portion 10 is likely to be increased in the vicinity of the raised bottom portion 37, and thus there is a concern that the rigidity is likely to differ between a position where the raised bottom portion 37 is disposed and the other positions in the tire width direction. When there is unevenness in the rigidity of the land portion 10, uneven wear is likely to occur due to the unevenness in the rigidity. For example, in the land portion 10, there is a concern that a difference in a ground contact pressure may occur due to the unevenness in the rigidity at the time of ground contact of the land portion 10, and this may cause a difference in progress of wear, causing uneven wear.

In contrast, in the present embodiment, the sipe 40 formed in the land portion 10 includes the shallow bottom portion 47 and the deep bottom portion 48 that differ from each other in a depth from the tread contact surface 3, and the deep bottom portion 48 is disposed in the central region CA of the land portion 10 in the tire width direction overlapping the raised bottom portion 37 of the lug groove 30 in the tire circumferential direction. Since the depth from the tread contact surface 3 of the deep bottom portion 48 of the sipe 40 is deeper than that of the shallow bottom portion 47, the rigidity of the land portion 10 in which the sipes 40 are formed is lower at a position where the deep bottom portion 48 is formed than at a position where the shallow bottom portion 47 is formed in the tire width direction. For this reason, the deep bottom portion 48 of the sipe 40 and the raised bottom portion 37 of the lug groove 30 are disposed overlapping each other in the tire circumferential direction, and thus it is possible to prevent the rigidity of the land portion 10 from becoming excessively high locally at the position where the raised bottom portion 37 of the lug groove 30 is disposed in the tire width direction. Accordingly, it is possible to suppress uneven wear due to large unevenness in the rigidity of the land portion 10. As a result, wear performance and uneven wear resistance performance can be provided in a compatible manner.

Also, for the lug groove 30 and the sipe 40, since the relationship between the maximum depth H1 of the lug groove 30 from the tread contact surface 3 and the maximum depth H2 of the sipe 40 from the tread contact surface 3 is within a range of 0.5≤(H2/H1)≤0.8, it is possible to ensure the drainage properties by the sipes 40 while ensuring the rigidity of the land portion 10 more reliably. In other words, when the relationship between the maximum depth H1 of the lug groove 30 and the maximum depth H2 of the sipe 40 is (H2/H1)<0.5, the maximum depth H2 of the sipe 40 is too small, and thus it may be difficult to ensure the drainage properties by the sipes 40. In that case, even when the sipes 40 are formed in the land portion 10, it may be difficult to effectively ensure wet performance that is running performance on wet road surfaces. On the other hand, when the relationship between the maximum depth H1 of the lug groove 30 and the maximum depth H2 of the sipe 40 is (H2/H1)>0.8, the maximum depth H2 of the sipe 40 is too large, and thus the rigidity of the land portion 10 may become too low due to the sipes 40 having the large maximum depth H2. In that case, even when the raised bottom portion 37 is formed in the lug groove 30, it may be difficult to ensure the rigidity of the land portion 10 and effectively ensure wear performance. In contrast, when the relationship between the maximum depth H1 of the lug groove 30 and the maximum depth H2 of the sipe 40 is within a range of 0.5≤(H2/H1)≤0.8, it is possible to ensure the drainage properties by the sipes 40 while ensuring the rigidity of the land portion 10 more reliably. As a result, wear performance and wet performance can be provided in a compatible manner.

Also, since the relationship between the depth D1 from the tread contact surface 3 to the raised bottom portion 37 of the lug groove 30 and the depth D2 from the tread contact surface 3 to the shallow bottom portion 47 of the sipe 40 is within a range of 0.8≤(D2/D1)≤1.2, it is possible to more reliably suppress the unevenness in the rigidity of the land portion 10. In other words, when the relationship between the depth D1 of the raised bottom portion 37 of the lug groove 30 and the depth D2 of the shallow bottom portion 47 of the sipe 40 is (D2/D1)<0.8, the depth D2 of the shallow bottom portion 47 of the sipe 40 is too shallow with respect to the depth D1 of the raised bottom portion 37, and thus the rigidity of the land portion 10 may become too high in a portion where the shallow bottom portion 47 of the sipe 40 is formed. On the other hand, when the relationship between the depth D1 of the raised bottom portion 37 of the lug groove 30 and the depth D2 of the shallow bottom portion 47 of the sipe 40 is (D2/D1)>1.2, the depth D2 of the shallow bottom portion 47 of the sipe 40 is too deep with respect to the depth D1 of the raised bottom portion 37, and thus the rigidity of the land portion 10 may become too low in a portion where the shallow bottom portion 47 of the sipe 40 is formed. In these cases, even when the sipe 40 including the shallow bottom portion 47 and the deep bottom portion 48 is formed in the land portion 10 defined by the lug grooves 30 in which the raised bottom portion 37 is disposed, it may be difficult to effectively suppress the unevenness in the rigidity of the land portion 10.

In contrast, when the relationship between the depth D1 of the raised bottom portion 37 of the lug groove 30 and the depth D2 of the shallow bottom portion 47 of the sipe 40 is within a range of 0.8≤(D2/D1)≤1.2, it is possible to prevent the difference in the rigidity of the land portion 10 between a position where the raised bottom portion 37 of the lug groove 30 and the deep bottom portion 48 of the sipe 40 are disposed overlapping in the tire circumferential direction and a position where the shallow bottom portion 47 of the sipe 40 is formed, in the tire width direction. As a result, wear performance and uneven wear resistance performance can be more reliably provided in a compatible manner.

Also, since the relationship between the width W1 of the raised bottom portion 37 of the lug groove 30 and the width W2 of the deep bottom portion 48 of the sipe 40 is within a range of 0.7≤(W2/W1)≤1.2, it is possible to suppress the unevenness in the rigidity of the land portion 10 while ensuring the rigidity of the land portion 10 more reliably. In other words, when the relationship between the width W1 of the raised bottom portion 37 of the lug groove 30 and the width W2 of the deep bottom portion 48 of the sipe 40 is (W2/W1)<0.7, the width W1 of the raised bottom portion 37 is too large, and thus the rigidity of the land portion 10 may become too high in the vicinity of a position where the raised bottom portion 37 is located in the tire width direction. In that case, even when the deep bottom portion 48 is provided in the sipe 40, it may be difficult to effectively suppress the unevenness in the rigidity of the land portion 10. On the other hand, when the relationship between the width W1 of the raised bottom portion 37 of the lug groove 30 and the width W2 of the deep bottom portion 48 of the sipe 40 is (W2/W1)>1.2, the width W2 of the deep bottom portion 48 of the sipe 40 is too large, and thus the rigidity of the land portion 10 in which the sipes 40 are formed may become too low.

In contrast, when the relationship between the width W1 of the raised bottom portion 37 of the lug groove 30 and the width W2 of the deep bottom portion 48 of the sipe 40 is within a range of 0.7≤(W2/W1)≤1.2, it is possible to more reliably suppress the unevenness in the rigidity of the land portion 10 by providing the sipe 40 with the deep bottom portion 48 that is disposed overlapping the raised bottom portion 37 of the lug groove 30 in the tire circumferential direction while preventing the rigidity of the land portion 10 from becoming too low due to the formation of the sipes 40 including the deep bottom portions 48. As a result, wear performance and uneven wear resistance performance can be more reliably provided in a compatible manner.

Also, since the sipe 40 includes a plurality of deep bottom portions 48 and at least part of the deep bottom portions 48 is disposed overlapping the raised bottom portion 37 in the tire circumferential direction, it is possible to suppress the unevenness in the rigidity of the land portion 10 while more reliably ensuring the drainage properties by the sipes 40. As a result, uneven wear resistance performance and wet performance can be more reliably provided in a compatible manner.

Also, the relationship between the width W1 of the raised bottom portion 37 of the lug groove 30 and the width W3 of the shallow bottom portion 47 located between the deep bottom portions 48 in the sipe 40 is within a range of 0.4≤(W3/W1)≤0.8, and it is possible to ensure the drainage properties by the sipes 40 while preventing the rigidity of the land portion 10 from becoming too low due to the formation of the sipes 40 including the shallow bottom portions 47 and the deep bottom portions 48. In other words, when the relationship between the width W1 of the raised bottom portion 37 of the lug groove 30 and the width W3 of the shallow bottom portion 47 of the sipe 40 is (W3/W1)<0.4, the width W3 of the shallow bottom portion 47 of the sipe 40 is too small, and thus the width W2 of the deep bottom portion 48 may become too large, and the rigidity of the land portion 10 in which the sipes 40 are formed may become too low. On the other hand, when the relationship between the width W1 of the raised bottom portion 37 of the lug groove 30 and the width W3 of the shallow bottom portion 47 of the sipe 40 is (W3/W1)>0.8, the width W3 of the shallow bottom portion 47 of the sipe 40 is too large, and thus the volume of the sipe 40 is reduced, and it may be difficult to ensure the drainage properties by the sipes 40.

In contrast, when the relationship between the width W1 of the raised bottom portion 37 of the lug groove 30 and the width W3 of the shallow bottom portion 47 of the sipe 40 is within a range of 0.4≤(W3/W1)≤0.8, it is possible to ensure the drainage properties by the sipes 40 while preventing the rigidity of the land portion 10 from becoming too low due to the formation of the sipes 40 including the shallow bottom portions 47 and the deep bottom portions 48. As a result, wear performance and wet performance can be more reliably provided in a compatible manner.

Also, since the width WL of the portion where the raised bottom portion 37 of the lug groove 30 and the deep bottom portion 48 of the sipe 40 overlap with each other in the tire circumferential direction is 40% or more of the width W1 of the raised bottom portion 37, it is possible to more reliably suppress the unevenness in the rigidity of the land portion 10 by the deep bottom portions 48 of the sipes 40 while ensuring the rigidity of the land portion 10 by the raised bottom portions 37 of the lug grooves 30. In other words, when the width WL of the portion where the raised bottom portion 37 and the deep bottom portion 48 overlap with each other in the tire circumferential direction is less than 40% of the width W1 of the raised bottom portion 37, the width WL of the portion where the raised bottom portion 37 and the deep bottom portion 48 overlap with each other is too small, and thus it may be difficult to suppress the unevenness in the rigidity of the land portion 10 even when the raised bottom portion 37 and the deep bottom portion 48 are disposed overlapping each other in the tire circumferential direction.

In contrast, when the width WL of the portion where the raised bottom portion 37 and the deep bottom portion 48 overlap with each other in the tire circumferential direction is 40% or more of the width W1 of the raised bottom portion 37, it is possible to more reliably prevent the rigidity of the land portion 10 from becoming high locally due to the raised bottom portions 37 of the lug grooves 30 by the deep bottom portions 48 of the sipes 40. As a result, it is possible to more reliably prevent the occurrence of the unevenness in the rigidity of the land portion 10 by the deep bottom portions 48 of the sipes 40 while ensuring the rigidity of the land portion 10 by the raised bottom portions 37 of the lug grooves 30. As a result, wear performance and uneven wear resistance performance can be more reliably provided in a compatible manner.

Also, since the raised bottom portion 37 of the lug groove 30 is disposed between the plurality of bent portions 36 included in the lug groove 30, it is possible to more reliably improve the edge effect during travel on icy and snowy road surfaces while suppressing uneven wear by ensuring the rigidity of the land portion 10 in the vicinities of the bent portions 36. In other words, the length of the edge of the lug groove 30 can be increased by providing the lug groove 30 with the plurality of bent portions 36, enabling the edge effect during travel on snow-covered road surfaces or icy road surfaces to be more reliably exerted. Thus, running performance during travel on icy and snowy road surfaces can be more reliably ensured. On the other hand, although the vicinities of the bent portions 36 of the lug groove 30 are portions where the rigidity of the land portion 10 is likely to be reduced and uneven wear is likely to occur, it is possible to ensure the rigidity of the land portion 10 in the vicinities of the bent portions 36 by disposing the raised bottom portion 37 between the bent portions 36. Accordingly, the occurrence of uneven wear due to reduction in the rigidity of the land portion 10 in the vicinities of the bent portions 36 can be suppressed, and thus it is possible to suppress uneven wear while more reliably ensuring the edge effect during travel on icy and snowy road surfaces. As a result, uneven wear resistance performance and running performance during travel on icy and snowy road surfaces can be more reliably provided in a compatible manner.

### Modified Examples

In the embodiment described above, the raised bottom portion 37 of the shoulder lug groove 35 and the deep bottom portion 48 of the shoulder sipe 45 are disposed overlapping each other in the tire circumferential direction, so that the rigidity of the shoulder land portion 15 is ensured and the unevenness in the rigidity is suppressed. However, the land portion 10 in which the raised bottom portion of the lug groove 30 and the deep bottom portion of the sipe 40 overlap with each other in the tire circumferential direction may be other than the shoulder land portion 15. In other words, the raised bottom portion of the lug groove 30 and the deep bottom portion of the sipe 40 may be disposed overlapping each other in the tire circumferential direction in grooves other than the shoulder lug groove 35 and the shoulder sipe 45. For example, when a deep bottom portion (not illustrated) is formed in the center sipe 41 overlapping the raised bottom portion 33 (see FIG. 1) formed in the center lug groove 31 in the tire circumferential direction, it is possible to ensure the rigidity of the center land portion 11 by the raised bottom portion 33 of the center lug groove 31 and suppress the unevenness in the rigidity of the center land portion 11 by the deep bottom portion of the center sipe 41. The land portion 10 that is defined by the lug grooves 30 and the land portion 10 in which the sipes 40 are formed do not matter as long as a raised bottom portion is formed in the central region CA of the land portion 10 in the tire width direction in the lug groove 30, a deep bottom portion is formed in the central region CA of the land portion 10 in the tire width direction in the sipe 40, and the raised bottom portion and the deep bottom portion are disposed overlapping each other in the tire circumferential direction. In this case, each of the numerical values designated in the embodiment is applied to the sipe 40 in which the deep bottom portion is formed and the lug groove 30 in which the raised bottom portion is formed.

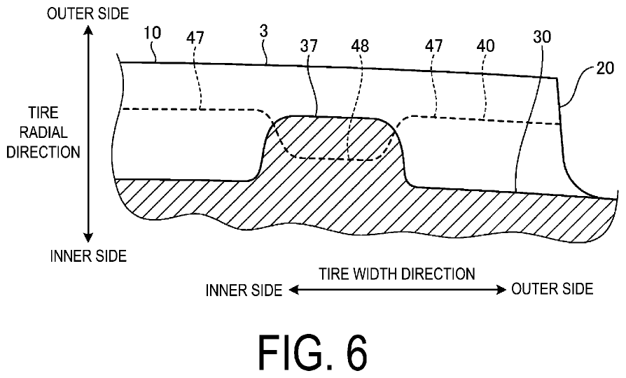

Further, in the embodiment described above, the shoulder sipe 45 includes the plurality of deep bottom portions 48, but the sipe 40 does not have to include the plurality of deep bottom portions 48. FIG. 6 is an explanatory diagram of a modified example of a pneumatic tire 1 according to an embodiment and an explanatory diagram of a case where the sipe 40 includes one deep bottom portion 48. As illustrated in FIG. 6, the sipe 40 may include one deep bottom portion 48. In other words, in the sipe 40, one deep bottom portion 48 may be formed, and the shallow bottom portions 47 may be disposed on both sides of the deep bottom portion 48 in the extension direction of the sipe 40 from the deep bottom portion 48 to the end portions in the extension direction of the sipe 40. Even in a case of one deep bottom portion 48 disposed in the sipe 40 as described above, at least part of the deep bottom portion 48 is disposed in the central region CA of the land portion 10 in the tire width direction, and the deep bottom portion 48 is disposed overlapping the raised bottom portion 37 included in the lug groove 30 in the tire circumferential direction. The raised bottom portion 37 formed in the lug groove 30 and the deep bottom portion 48 are disposed overlapping each other in the tire circumferential direction, and thereby the sipe 40 can prevent the rigidity of the land portion 10 from becoming high locally in the vicinity of a portion where the raised bottom portion 37 is disposed in the tire width direction, and can suppress the unevenness in the rigidity of the land portion 10, regardless of the number of the deep bottom portions 48. Accordingly, wear performance and uneven wear resistance performance can be provided in a compatible manner. Also, in the embodiment described above, the sipe 40 includes the shallow bottom portion and the deep bottom portion, and the deep bottom portion of the sipe 40 overlaps with the raised bottom portion of the lug groove 30 in the tire circumferential direction. However, the deep bottom portion that overlaps with the raised bottom portion of the lug groove 30 in the tire circumferential direction may be included in a portion other than the sipe 40. A groove in which a deep bottom portion overlapping the raised bottom portion of the lug groove 30 in the tire circumferential direction may be, for example, a narrow groove (not illustrated) having a groove width larger than the groove width of the sipe 40, and the narrow groove may include a shallow bottom portion and a deep bottom portion, and the deep bottom portion of the narrow groove having a groove width larger than the groove width of the sipe 40 may be disposed overlapping the raised bottom portion of the lug groove 30 in the tire circumferential direction. In other words, for a narrow groove including a shallow bottom portion and a deep bottom portion in which the deep bottom portion is disposed overlapping the raised bottom portion of the lug groove 30 in the tire circumferential direction, the groove width of the narrow groove doesn't matter as long as the groove width is within a range of 0.5 mm or more and 1.0 mm or less including the sipe 40.

Further, in the embodiment described above, three main grooves 20 are formed in the pneumatic tire 1, but the number of main grooves 20 may be other than three. Furthermore, the above-described embodiment and modified example may be combined as appropriate. In the embodiment described above, although the pneumatic tire 1 is used for description as an example of the tire according to the embodiment of the present technology, the tire according to the embodiment of the present technology may be a tire other than the pneumatic tire 1. The tire according to the embodiment of the present technology may be, for example, a so-called airless tire that can be used without filling a gas.

### Examples

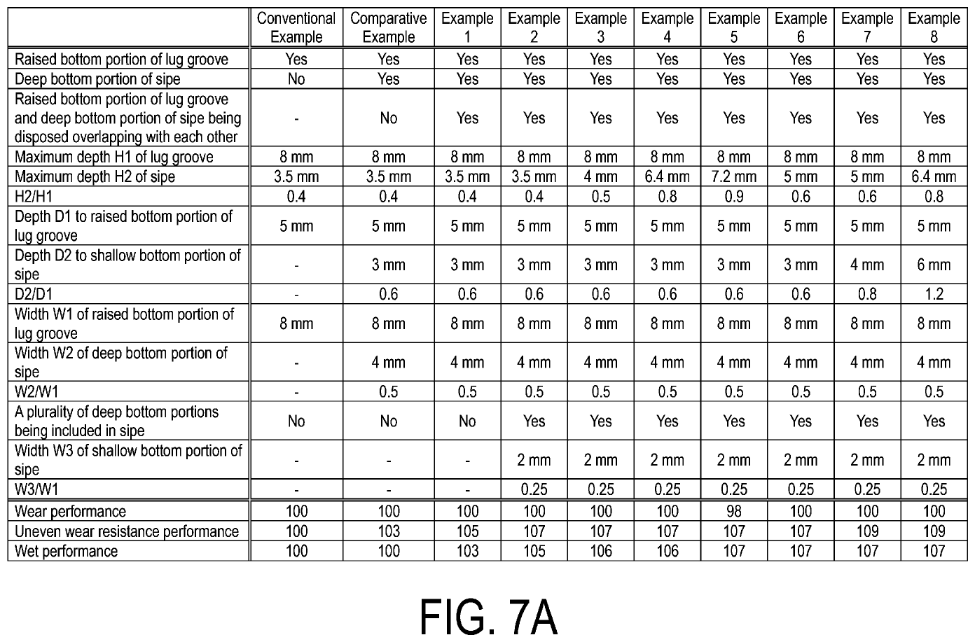

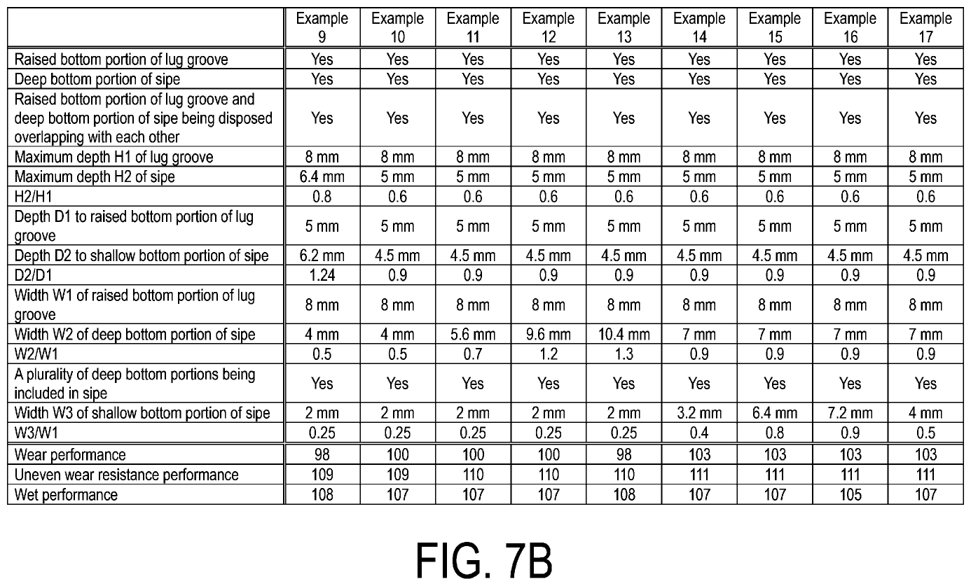

FIGS. 7A and 7B are tables showing the results of performance evaluation tests performed on a pneumatic tire. For the pneumatic tire described above, description will be given of performance evaluation tests conducted on a pneumatic tire according to a Conventional Example, the pneumatic tire according to the embodiment of the present technology, and a pneumatic tire according to a Comparative Example to be compared with pneumatic tire according to the embodiment of the present technology. In the performance evaluation tests, wear performance that is durability performance against wear, uneven wear resistance performance that is performance regarding the unlikelihood of generation of uneven wear, and wet performance that is running performance on wet road surfaces were tested.

The performance evaluation tests were performed by mounting pneumatic tires 1 each having a tire nominal size of 235/65R16C 115/113R specified by JATMA on JATMA standard rim wheels each having a rim size of 16×7.0 J, mounting the test tires on a 4WD evaluation vehicle, adjusting air pressure of front tires to 250 kPa and rear tires to 380 kPa, and then driving the evaluation vehicle.

As for evaluation methods for respective test items, wear performance was evaluated by carrying out a road test with the evaluation vehicle mounted with the test tires, measuring the amount of remaining groove after a travel of 10,000 km, and calculating a difference between the groove depth after the travel of 10,000 km and the initial groove depth as an amount of wear. Wear performance was evaluated by expressing the reciprocal of the calculated amount of wear as an index value with Conventional Example to be described later being assigned the value of 100. Larger index values indicate less amount of wear and superior wear performance. When the index value of wear performance is 98 or more, it is assumed that degradation in wear performance is suppressed as compared to Conventional Example and wear performance at least equivalent to Conventional Example is ensured.

Also, uneven wear resistance performance was evaluated by carrying out a road test with the evaluation vehicle mounted with the test tires, measuring the amount of remaining groove after a travel of 10,000 km, and calculating an uneven wear ratio based on an amount of wear in the center land portion and an amount of wear in the shoulder land portion. Uneven wear resistance performance was evaluated by expressing the reciprocal of the calculated uneven wear ratio as an index value with Conventional Example to be described later being assigned the value of 100. Larger index values indicate less uneven wear and superior uneven wear resistance performance.

Also, wet performance was evaluated by carrying out a braking test with the evaluation vehicle mounted with the test tires on a test course including wet road surfaces and expressing the reciprocal of a braking distance as an index with Conventional Example to be described later being assigned the value of 100. Larger index values indicate shorter braking distance on wet road surfaces and superior wet performance.

The performance evaluation tests were conducted on 19 types of pneumatic tires including a pneumatic tire according to Conventional Example that is an example of a conventional pneumatic tire, Examples 1 to 17 that are the pneumatic tires 1 according to the present technology, and Comparative Example that is a pneumatic tire to be compared with the pneumatic tires 1 according to the present technology. Any of the pneumatic tires of Conventional Example, Comparative Example, and Examples 1 to 17 includes raised bottom portions formed in lug grooves. Of these, Conventional Example includes sipes formed at a constant depth and include no deep bottom portions. Also, in Comparative Example, sipes include deep bottom portions, but the deep bottom portions of the sipes are not disposed overlapping the raised bottom portions of the lug grooves in the tire circumferential direction.

In contrast, in all of Examples 1 to 17 that are examples of the pneumatic tires according to the present technology, the sipe includes the deep bottom portion, and the deep bottom portion of the sipe is disposed overlapping the raised bottom portion of the lug groove in the tire circumferential direction. Further, the pneumatic tires according to Examples 1 to 17 differ from each other in the ratio of the maximum depth H2 of the sipe to the maximum depth H1 of the lug groove (H2/H1), the ratio of the depth D2 to the shallow bottom portion of the sipe to the depth D1 to the raised bottom portion of the lug groove (D2/D1), the ratio of the width W2 of the deep bottom portion of the sipe to the width W1 of the raised bottom portion of the lug groove (W2/W1), whether a plurality of the deep bottom portions is included in the sipe, and the ratio of the width W3 of the shallow bottom portion of the sipe to the width W1 of the raised bottom portion of the lug groove (W3/W1).

As a result of the performance evaluation tests conducted using these pneumatic tires 1, it was found that, as shown in FIGS. 7A and 7B, the pneumatic tires according to Examples 1 to 17 can improve uneven wear resistance performance while suppressing the degradation in wear performance as much as possible and improve combined overall performance of wear performance and uneven wear resistance performance, compared with Conventional Example and Comparative Example. In other words, the pneumatic tires according to Examples 1 to 17 can provide wear performance and uneven wear resistance performance in a compatible manner.

1. A tire, comprising:
a main groove extending in a tire circumferential direction;
a lug groove extending in a tire width direction;
a land portion defined by the main groove and the lug groove; and
a narrow groove that is formed in the land portion, extends in the tire width direction, and comprises at least one end opening to the main groove,
the lug groove comprising a raised bottom portion formed in a central region of the land portion in the tire width direction,
the narrow groove comprising a shallow bottom portion and a deep bottom portion having different depths from a tread contact surface,
the deep bottom portion having a depth from the tread contact surface greater than a depth of the shallow bottom portion and comprising at least part disposed in the central region, and
the raised bottom portion and the deep bottom portion being disposed overlapping each other in the tire circumferential direction.

2. The tire according to claim 1, wherein
the lug groove and the narrow groove have a relationship between a maximum depth H1 of the lug groove from the tread contact surface and a maximum depth H2 of the narrow groove from the tread contact surface of within a range of 0.5≤(H2/H1)≤0.8.

3. The tire according to claim 1, wherein
the lug groove and the narrow groove have a relationship between a depth D1 from the tread contact surface to the raised bottom portion of the lug groove and a depth D2 from the tread contact surface to the shallow bottom portion of the narrow groove of within a range of 0.8≤(D2/D1)≤1.2.

4. The tire according to claim 1, wherein
the lug groove and the narrow groove have a relationship between a width W1 of the raised bottom portion of the lug groove and a width W2 of the deep bottom portion of the narrow groove of within a range of 0.7≤(W2/W1)≤1.2.

5. The tire according to claim 1, wherein
the narrow groove comprises a plurality of the deep bottom portions, and
at least part of the deep bottom portions is disposed overlapping the raised bottom portion in the tire circumferential direction.

6. The tire according to claim 5, wherein
the lug groove and the narrow groove have a relationship between a width W1 of the raised bottom portion of the lug groove and a width W3 of the shallow bottom portion located between the deep bottom portions of the narrow groove of within a range of 0.4≤(W3/W1)≤0.8.

7. The tire according to claim 1, wherein
the lug groove and the narrow groove have a width WL of a portion in which the raised bottom portion and the deep bottom portion overlap with each other in the tire circumferential direction of 40% or more of a width W1 of the raised bottom portion.

8. The tire according to claim 1, wherein
the lug groove comprises a plurality of bent portions bent in the tire circumferential direction while extending in the tire width direction, and
the raised bottom portion is disposed between the bent portions.

9. The tire according to claim 2, wherein
the lug groove and the narrow groove have a relationship between a depth D1 from the tread contact surface to the raised bottom portion of the lug groove and a depth D2 from the tread contact surface to the shallow bottom portion of the narrow groove of within a range of 0.8≤(D2/D1)≤1.2.

10. The tire according to claim 9, wherein
the lug groove and the narrow groove have a relationship between a width W1 of the raised bottom portion of the lug groove and a width W2 of the deep bottom portion of the narrow groove of within a range of 0.7≤(W2/W1)≤1.2.

11. The tire according to claim 10, wherein
the lug groove and the narrow groove have a width WL of a portion in which the raised bottom portion and the deep bottom portion overlap with each other in the tire circumferential direction of 40% or more of a width W1 of the raised bottom portion.

12. The tire according to claim 11, wherein
the lug groove comprises a plurality of bent portions bent in the tire circumferential direction while extending in the tire width direction, and
the raised bottom portion is disposed between the bent portions.

13. The tire according to claim 6, wherein
the lug groove and the narrow groove have a width WL of a portion in which the raised bottom portion and the deep bottom portion overlap with each other in the tire circumferential direction of 40% or more of a width W1 of the raised bottom portion.

14. The tire according to claim 13, wherein
the lug groove comprises a plurality of bent portions bent in the tire circumferential direction while extending in the tire width direction, and
the raised bottom portion is disposed between the bent portions.
